(19) United States
(12) Patent Application Publication
(10) Pub. No.: US 2002/0123824 A1
(43) Pub. Date: Sep. 5, 2002

(54) System and method for controlling cooking appliance using computer-readable label

(76) Inventor: Edward Randall Furlong, Niskayuna, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/681,227

(22) Filed: Mar. 1, 2001

(51) Int. Cl. G06F 19/00

(52) U.S. Cl. 700/211

(57) ABSTRACT

A system for controlling a cooking appliance in the preparation of a food item includes a computer-readable label provided on a package of a food item to be cooked in accordance with a set of cooking instructions with the label having contents identifying the food item, a database containing sets of cooking instructions for different food items, and a subsystem for reading the contents of the label, communicating the contents of the label to the database, accessing the set of cooking instructions for the food item from the database, and transferring the cooking instructions into a cooking appliance for execution by the consumer by operating the appliance.

### BACKGROUND OF INVENTION

The present invention generally relates to food preparation and, more particularly, is concerned with a system and method that uses a computer-readable label in controlling the settings of a cooking appliance for the preparation of a food item.

Many prepared food items require multi-stage cooking for optimum quality. However, many consumers find waiting by a particular cooking appliance, such as a microwave oven, in order to make the required settings in the correct sequence at the proper times to be burdensome and would prefer to make a single setting and then collect the heated food at the end of the cooking sequence. This affects the consumers' perception about the quality of the prepared food. In addition, many consumers prefer the convenience of single-button cooking such as the “Popcorn” button common on microwave ovens.

Consequently, a need exists for an innovation which will allow consumers to access and execute cooking instructions for a particular food item in a way that will be easy and not require exercise of substantial individual skill or judgment concerning the instructions.

### SUMMARY OF INVENTION

The present invention provides a system and method designed to satisfy the aforementioned need by relieving consumers of the obligation of being able or willing to follow detailed cooking instructions. The system and method of the present invention uses computer-readable labels, provided such as on a food package, to allow consumers to access and execute cooking instructions for the particular food item purchased in the food package. Once the cooking instructions are accessed by using the computer-readable label, the cooking instructions are easily downloaded and programmed into and executed by the cooking appliance so as to control the settings of the cooking appliance for and guide the consumer through the preparation of the particular food item. Cooking instructions so provided are easy for all consumers to execute without the necessity of exercising any substantial individual skill or judgment to properly carry out the instructions.

In one embodiment of the present invention, a system for controlling a cooking appliance in the preparation of a food item is provided which comprises a computer-readable label provided on a package of a food item to be cooked in accordance with a set of cooking instructions with the label having contents identifying the food item, a database containing sets of cooking instructions for different food items, and a subsystem for reading the contents of the label, for communicating the contents of the label to the database, for accessing the set of cooking instructions for the food item from the database, and for transferring the cooking instructions into a cooking appliance for execution by the consumer by operating the appliance.

More particularly, the subsystem includes a laser scanner device for reading the contents of the label on the package, a computer and a modem and keyboard connected in communication with the computer. The modem is used for connecting the computer to the Internet in order to communicate the contents of the label to the database via the Internet, access the set of cooking instructions for the food item from the database, and transfer the cooking instructions into a cooking appliance for execution by the consumer by operating the appliance.

In another embodiment of the present invention, a method for controlling a cooking appliance in the preparation of a food item is provided which comprises the steps of providing a computer-readable label on a package of a food item containing a food item to be cooked in accordance with a set of cooking instructions with the label having contents identifying the food item, providing a database containing sets of cooking instructions for different food items, reading the contents of the label, communicating the contents of the label to a database containing cooking instructions for the food item, accessing the set of cooking instructions for the food item from the database, and transferring the cooking instructions into a cooking appliance for execution by the consumer by operating the appliance.

### BRIEF DESCRIPTION OF DRAWINGS

FIG. 1 is a block diagram of a system of the present invention for controlling a cooking appliance in the preparation of a food item in which a subsystem employed by the system is built into the appliance.

FIG. 2 is a block diagram of the system of the present invention similar to that of FIG. 1 except that the subsystem employed by the system is separate from the appliance.

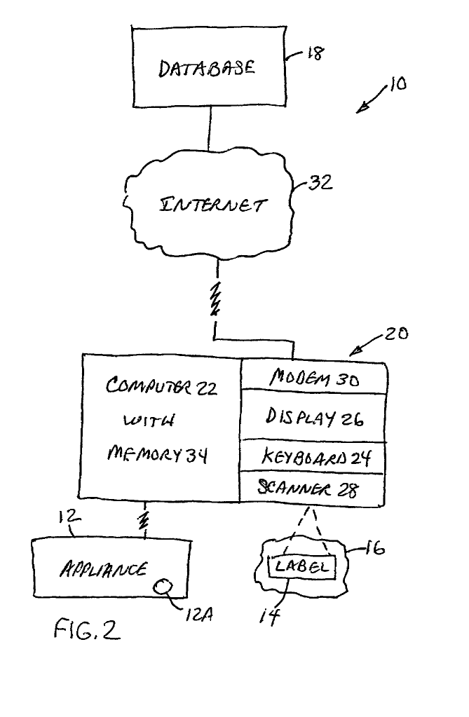

FIG. 3 is a flow diagram of the steps of a method of the present invention for controlling a cooking appliance in the preparation of a food item.

### DETAILED DESCRIPTION

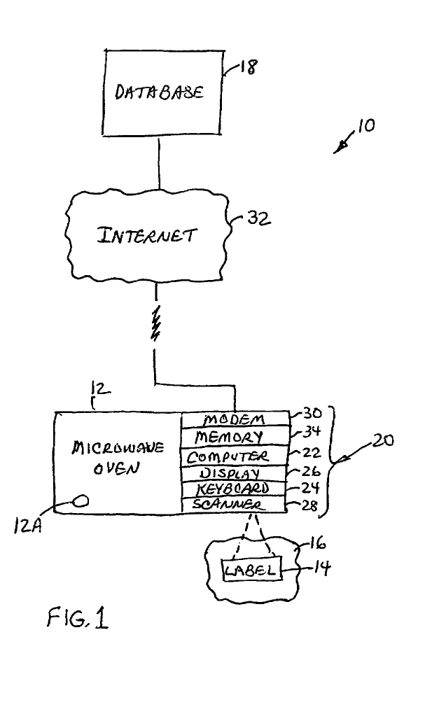

Referring now to the drawings and particularly to FIG. 1, there is illustrated a system, generally designated 10, for controlling a cooking appliance 12 in the preparation of a food item. The system 10 includes a computer-readable label 14 provided on a package 16 of a food item to be cooked in accordance with a set of cooking instructions with the label 14 having contents identifying the food item, a database 18 containing sets of cooking instructions for different food items, and a subsystem 20 for reading the contents of the label 14, communicating the contents of the label 14 to the database 18, accessing the set of cooking instructions for the food item from the database 18, and transferring the cooking instructions into the cooking appliance 12 for execution by the consumer by operating the appliance 12. The computer-readable label 14 on the package 16 in which the food item was purchased allows consumers to easily access and then readily execute the cooking instructions for the particular food item.

The subsystem 20 includes a computer 22 and a keyboard 24, a display 26, a laser scanner device 28 and a modem 30 connected in communication with the computer 22. The laser scanner device 28 employs a widely available laser scanning technology to read the computer-readable label 14 on the package 16 of the food item. The computer readable label 14 can rely on many technologies, such as a UPC code, or a RF tagger, or other descriptive label. The modem 30 is used to establish communication via the Internet 32 between the computer 22 and the database 18 which is maintained by a vendor of food items or appliances or by some other entity to access the optimal cooking instructions such as for the particular appliance owned by the consumer. The cooking instructions are downloaded via the Internet 32 from the remote database 20 to the consumer's computer 22 and transferred or programmed into the cooking appliance 12 by appropriate software provided in the computer 22. The consumer can then begin the cooking process, such as by pressing a single button 12A provided on the appliance 12. The food items most recently used by the consumer are stored locally in a memory 34 of the computer 22 to speed the response time in accessing the set of cooking instructions. The aforementioned components employed by the subsystem 20, the computer 22, keyboard 24, display 26, laser scanner device 28 and modem 30, can be any suitable well-known off-the-shelf conventional components. The subsystem 20 employed by the system 10 can be built into the appliance 12, as seen in FIG. 1, or can be provided as a separate standalone subsystem 20.

For ease of implementation in a household environment, a communications link can be established between the computer 22 of the system 10 of the present invention using any suitable technique. One suitable technique is to employ a Bluetooth technology-based platform such as described in detail in an article entitled “BLUETOOTH—The universal radio interface for ad hoc, wireless connectivity” by jaap Haartsen, published in Ericsson Review, No. 3, 1998, pp. 110-117. Bluetooth technology provides for local wireless connectivity between electronic devices. In particular, it is a universal radio interface in the 2.45 GHz frequency band that enables electronic devices to connect and communicate wirelessly via a short-range ad hoc network, such as can be formed by the appliance and/or computer and the internet.

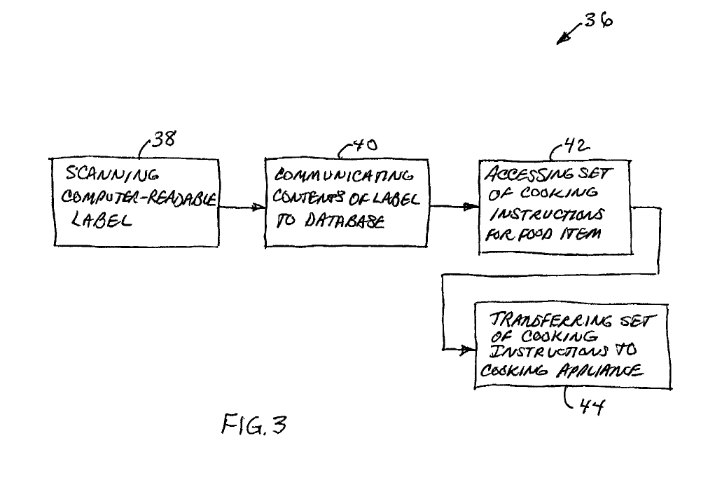

To recapitulate, the system 10 of the present invention can be employed to access, program and control the cooking times of cooking appliances 12, both microwave ovens and conventional ovens. The system 10 operates in accordance with the method of the present invention which, as illustrated in the flow diagram 36 of FIG. 3, includes the steps of scanning the computer-readable label 14, as represented by block 38, on the package 16 of the food item to be cooked, such as a prepared frozen food item, in accordance with the set of cooking instructions so as to read contents of the label 14 identifying the food item, communicating the contents of the label 14 to the database 18, as represented by block 40, containing sets of cooking instructions for different food item, accessing the set of cooking instructions for the particular food item from the database 18, as represented by block 42, and transferring the set of cooking instructions into the cooking appliance 12, as represented by block 44, for execution by the consumer by operating the appliance 12. In addition to using the computer-readable labels 14, the system 10 could also download cooking instructions from recipe software and the Internet. The system 10 could potentially be used to gather information about consumer preferences when the vendor is contacted for accessing the set of cooking instructions therefrom. The end result of utilization of system 10 of the present invention is to optimize cooking instructions which have the most impact on mixed-mode cooking such as defrost then cook, bake then broil, microwave plus radiant heat, etc.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

1. A system for controlling a cooking appliance in the preparation of a food item, comprising:
a computer-readable label provided on a package of a food item to be cooked in accordance with a set of cooking instructions, said label having contents identifying the food item;
a database containing sets of cooking instructions for different food items;
a subsystem for reading said contents of said label, communicating said contents of said label to said database, accessing said set of cooking instructions for the food item from said database, and transferring said set of cooking instructions into a cooking appliance for execution by the consumer by operating the appliance.

2. The system of claim 1 in which said subsystem includes a laser scanner device for reading said contents of said label on the package.

3. The system of claim 1 in which said subsystem includes a computer and a modem and a keyboard connected in communication with said computer for connecting said computer to the Internet and communicating said contents of said label to said database via the Internet, accessing said set of cooking instructions for the food item from said database, and transferring said set of cooking instructions into a cooking appliance for execution by the consumer by operating the appliance.

4. The system of claim 3 in which said subsystem further includes a display connected in communication with said computer.

5. The system of claim 3 in which said computer includes a modem connected to said computer and adapted to establish communication via the Internet with said database to access said set of cooking instructions.

6. The system of claim 1 in which said computer-readable label is a UPC label.

7. The system of claim 1 in which said database is one maintained by a vendor of the appliance.

8. A Method for controlling a cooking appliance in the preparation of a food item, comprising the steps of:
scanning a computer-readable label on a package of a food item to be cooked in accordance with a set of cooking instructions so as to read contents of the label identifying the food item;
communicating the contents of the label to a database containing sets of cooking instructions for different food item;
accessing the set of cooking instructions for the particular food item from the database; and
transferring the set of cooking instructions into a cooking appliance for execution by the consumer by operating the appliance.

9. The method of claim 8 in which the computer-readable label is a UPC label.

10. The method of claim 8 in which the database is one maintained by a vendor of the cooking appliance.

11. The method of claim 8 in which the Internet is used to communicate the contents of the label to the database.

12. The method of claim 11 in which the cooking instructions are downloaded via the Internet from the database to a computer which then transfers the cooking instructions to the cooking appliance.

13. The method of claim 12 in which the set of instructions for the food items most recently used by the consumer are stored in a memory of the computer to speed the response time in accessing the cooking instructions.

14. The method of claim 8 in which a consumer executes the set of cooking instructions process by pressing a single button provided on the cooking appliance.
